(19) United States
(12) Patent Application Publication
(10) Pub. No.: US 2010/0107976 A1
(43) Pub. Date: May 6, 2010

(54) Holder for Large Components with Improved Spray Protection

(76) Inventors: Sascha Martin Kyeck, Berlin (DE); Francis-Jurjen Ladru, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/611,180

(22) Filed: Nov. 3, 2009

(30) Foreign Application Priority Data
Nov. 4, 2008 (EP) 08019281.8

(51) Int. Cl. B05C 13/02

(52) U.S. Cl. 118/500

(57) ABSTRACT

A holder for a component providing spray protection is provided. The insertion of a rod in the side face of the component, the side face is arranged within a housing of the holder, has the additional effect of providing spray protection. The rod rests on an inner face of the holder in one aspect.

### CROSS REFERENCE TO RELATED APPLICATIONS

This application claims priority of European Patent Office application No. 08019281.8 EP filed Nov. 4, 2008, which is incorporated by reference herein in its entirety.

### FIELD OF INVENTION

The invention relates to a holder for turbine blades or vanes with improved spray protection.

### BACKGROUND OF INVENTION

During thermal spraying, it is necessary to use structural features and process management to protect those regions which are not to be coated against so-called overspray. At present, surfaces which are not to be coated are protected by using devices which cover the regions to be protected by means of protective plates (so-called transition plates in the case of direct contact between the device and the component). In the case of large components, these protective plates are so long that the process-related increase in the temperature of the device leads to warping and therefore “folding away”. This movement exposes a gap between the component and the device, and sprayed material then penetrates into this gap and is deposited there. Furthermore, the protective plates are subject to wear, as a result of which this thermally-induced gap increases in size over time. Structural countermeasures on the protective plate have failed owing to the restrictions which the coating robot faces when trying to access the component.

There is currently no satisfactory approach to a solution, and therefore the affected components, until now, have had to be remachined.

### SUMMARY OF INVENTION

The object of the invention is to solve the problem mentioned above.

The object is achieved by a device as claimed in the claims.

The dependent claims contain further advantageous measures which can be combined with one another as desired in order to achieve further advantages.

An insertion plate (rod, bar, plate) has been designed since it is not possible to reinforce the previous design; this plate is inserted in the interlocking region, i.e. in the groove from the sealing plate of the blade or vane, and therefore efficiently protects that region of the blades or vanes which is not to be coated against overspray. Overspray which is deposited on the plate can be removed after the coating process with a simple tool, e.g. a screwdriver, three-square scraper etc.

It is not necessary to carry out any complicated reworking at the previously affected points (removal of overspray), and the actual design of the device remains unchanged since the insertion plate is an additional measure. At this point, it should be emphasized that this solution makes it possible, for the first time, to successfully provide 100% protection against overspray even for those regions on which no reworking whatsoever is permitted.

### BRIEF DESCRIPTION OF THE DRAWINGS

In the figures:

FIGS. 1, 2, 3 and 4 show different views of a device or parts of this device,

FIG. 5 shows a gas turbine, and

FIG. 6 shows a turbine blade or vane.

The description and the figures illustrate only exemplary embodiments of the invention.

### DETAILED DESCRIPTION OF INVENTION

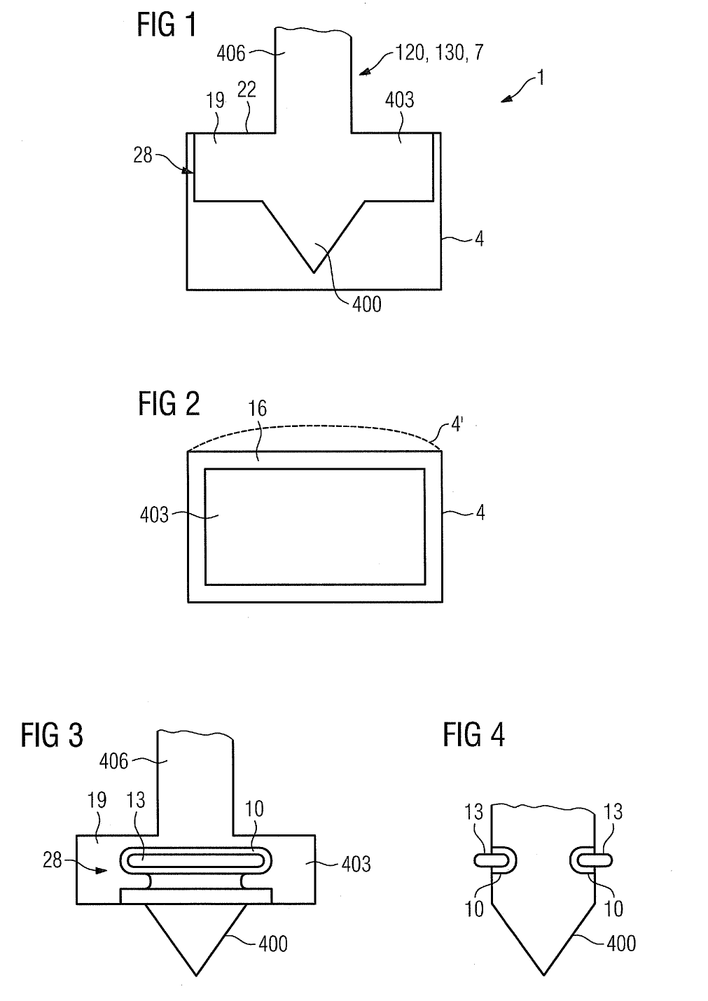

FIG. 1 shows a holder 4 for large components 7, 120, 130. The invention is explained, only by way of example, with reference to turbine blades or vanes 120, 130. A preferred holder 4 of this type is described in EP 1 808 269 A1. A turbine blade or vane 120, 130 or, in general terms, a component 7 is arranged in a holder 4 of this type. Certain regions of the component 7 should not be coated, and so these are simultaneously also covered by the holder 4. In this case, by way of example, the side faces of the blade or vane platforms 403 of the turbine blade or vane 120, 130 should not be coated, but rather only the top side 22 of the blade or vane platform 403 and the main blade or vane part 406.

In the case of particularly large components, the gap 16 between the blade or vane platform 403 and the holder 4 becomes warped 4′ (FIG. 2), and so the coating material penetrates into undesirable regions. In FIG. 2, this is indicated for one side of the holder 4 by the dashed line 4′.

Therefore, a rod 13, bar or plate is inserted, as part of the device 1, into a recess 10 in the side face 19 of the blade or vane platform 403 (FIG. 4). It may be necessary to redesign the turbine blade or vane 120, 130 so as to provide such a recess 10 or groove 10.

The rod 13 preferably projects beyond the recess 10. At room temperature, the rod 13 likewise preferably comes very close to the inner side of the holder 4 (housing) or rests on it 4.

The rod 13 preferably extends in this recess 10 over the entire length of the recess (groove) 10 (FIG. 3). This provides effective protection of the component 7, 120, 130 within the holder 4. The recess 10 is preferably as long as possible.

FIG. 2 shows a plan view of the holder 4, the blade or vane platform 403 and the gap 16 between the holder 4 and the blade or vane platform 403.

The holder 4 preferably has a rectangular design. The rods 13 are preferably present only on the longest sides. They may also be present on all four sides.

The rod 13 is preferably thicker than the wall of the housing 4 in the region 28 of the recess 10. This ensures good mechanical stability.

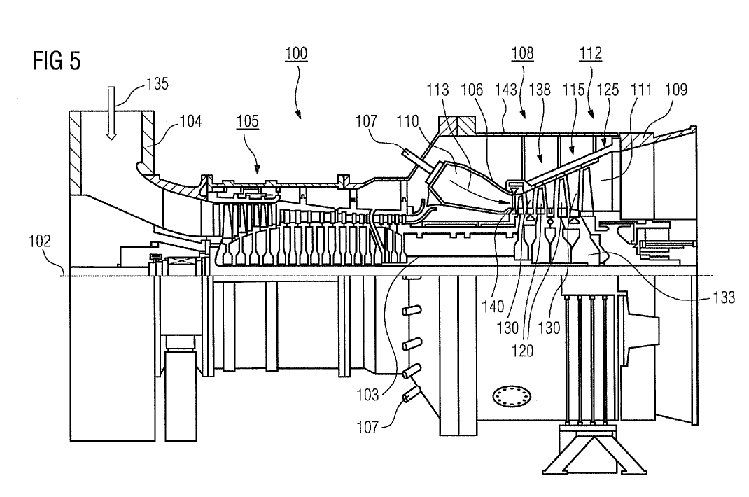

FIG. 5 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 fowl the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may also have coatings which protect against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element or hafnium). Alloys of this type are known from EP 0 486 489 B1, EP 0 786 017 B1, EP 0 412 397 B1 or EP 1 306 454 A1.

A thermal barrier coating, consisting for example of ZrO₂, Y₂O₃-ZrO₂, i.e. unstabilized, partially stabilized or fully stabilized by yttrium oxide and/or calcium oxide and/or magnesium oxide, may also be present on the MCrAlX.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

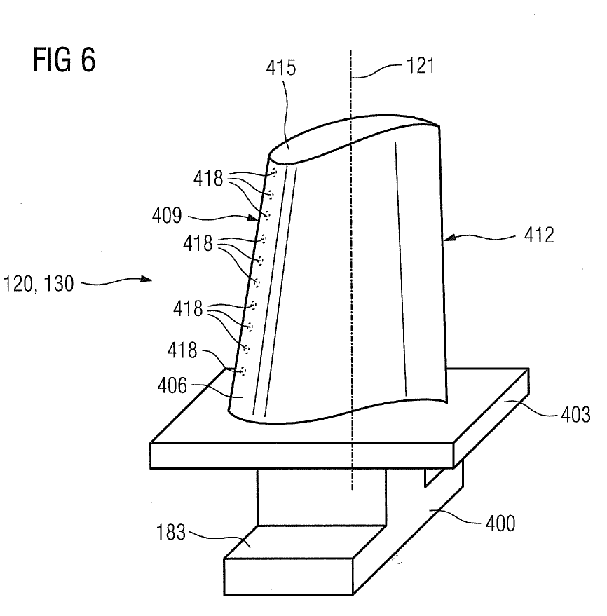

FIG. 6 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8A1-0.6Y-0.7Si or Co-28Ni-24Cr-10A1-0.6Y. In addition to these cobalt-base protective coatings, it is also preferable to use nickel-base protective layers, such as Ni-10Cr-12A1-0.6Y-3Re or Ni-12Co-21Cr-11Al-0.4Y-2Re or Ni-25Co-17Cr-10A1-0.4Y-1.5Re.

It is also possible for a thermal barrier coating, which is preferably the outermost layer and consists for example of ZrO₂, Y₂O₃-ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form.

If the blade or vane 120, 130 is to be cooled, it is hollow and may also have film-cooling holes 418 (indicated by dashed lines).

1-5. (canceled)

6. A holder for a component, comprising:
a housing;
a part of the component; and
a rod,
wherein the part of the component is arranged in the housing,
wherein the rod is loosely inserted in a recess on a side face of the component, and
wherein the rod is arranged within the holder.

7. The holder as claimed in claim 6, wherein the rod rests on an inner face of the holder.

8. The holder as claimed in claim 6, wherein a first length of the rod is at least 75% of a second length of the component.

9. The holder as claimed in claim 6, wherein the rod is thicker than a wall of the housing in a region of the recess.

10. The holder as claimed in claim 6, wherein the rod projects out of the recess.

11. The holder as claimed in claim 6, wherein the component is a blade platform including a blade root for a turbine blade.

12. The holder as claimed in claim 6, wherein the component is a vane platform including a vane root for a turbine vane.

13. The holder as claimed in claim 6, wherein the holder is rectangular in shape.

14. The holder as claimed in claim 13, wherein a plurality of rods are disposed on the two longer sides of the rectangular shape.

15. The holder as claimed in claim 13, wherein the plurality of rods are disposed on all four sides of the rectangular shape.
